(19) United States
(12) Patent Application Publication
(10) Pub. No.: US 2015/0029626 A1
(43) Pub. Date: Jan. 29, 2015

(54) CONTROLLER AREA NETWORK NODE TRANSCEIVER

(71) Applicant: MYSON CENTURY, INC., HSINCHU (TW)

(72) Inventors: TSEN-SHAU YANG, HSINCHU (TW); YUAN-CHIH CHUNG, HSINCHU (TW); PO YUAN LIN, HSINCHU (TW)

(73) Assignee: MYSON CENTURY, INC., HSINCHU (TW)

(21) Appl. No.: 14/037,705

(22) Filed: Sep. 26, 2013

(30) Foreign Application Priority Data
Jul. 29, 2013 (TW) 102127040

(51) Int. Cl. H04L 12/26; H02H 9/02

(52) U.S. Cl. CPC H04L 43/08; H02H 9/02; H02H 9/025
USPC 361/57

(57) ABSTRACT

An electronic device comprises a control module, a transceiving module, a first isolator, and a second isolator. The control module is configured to generate a control signal in response to a signal from an MCU. The transceiving module comprises a transceiving unit, which further comprises a first switch and a second switch. The electronic device further comprises a first isolator and a second isolator. The first isolator is external to the transceiving unit and is coupled between the first switch and a bus. Moreover, the first isolator is configured to isolate a first spike current coming from the bus. The second isolator is external to the transceiving unit and is coupled between a terminal of the second switch and the bus. Moreover, the second isolator is configured to direct a second spike current coming from the bus to the ground.

### TECHNICAL FIELD

The present disclosure is generally related to a transceiver and, more particularly, to a controller area network (CAN) node transceiver.

### BACKGROUND

Development of a controller area network (CAN) began in the 1980s and was published by the International Organization for Standardization (ISO). CAN is applied under harsh conditions of electrical transmitting for providing a stable transmission. Therefore, a CAN is usually applied on, for example, a control system of vehicles, aerospace, maritime, industrial automation and medical equipment. In case a signal wire of a differential bus is broken, grounded, or connected to a power cord, a CAN utilizes a two-wire differential transmitting protocol for continually providing signals.

CAN includes a controller which transmits signals of a micro-control unit (MCU) to a transceiver. The transceiver then broadcasts the signals over a bus. Moreover, the controller is integrated with the MCU by, for example, a digital process, in an electronic device. However, since the transceiver belongs to an analog component, it is difficult to integrate the transceiver with the controller in an electronic device.

The present disclosure provides a CAN node transceiver that includes a transceiver and a controller integrated with each other.

### SUMMARY

In accordance with one embodiment of the present disclosure, an electronic device comprises a control module, a transceiving module, a first isolator, and a second isolator.

The control module is configured to generate a control signal in response to a signal from an MCU. The transceiving module comprises a transceiving unit, which further comprises a first switch and a second switch. Moreover, the transceiving module is configured to, in response to the control signal, broadcast a first electrical signal to a bus and receive a second electrical signal sent over the bus.

The electronic device further comprises a first isolator and a second isolator. The first isolator is external to the transceiving unit and is coupled between the first switch and the bus. Moreover, the first isolator is configured to isolate a first spike current coming from the bus. The second isolator is external to the transceiving unit and is coupled between a terminal of the second switch and the bus. Moreover, the second isolator is configured to direct a second spike current coming from the bus to the ground.

In accordance with one embodiment of the present disclosure, a signal transceiving module comprises a transceiving unit, which comprises a first switch and a second switch. The transceiving module further comprises a first isolator and a second isolator. The first isolator is external to the transceiving unit and is coupled between the first switch and a bus. Moreover, the first isolator is configured to isolate a first spike current coming from the bus. The second isolator is external to the transceiving unit and is coupled between a terminal of the second switch and the bus. Moreover, the second isolator is configured to direct a second spike current coming from the bus to the ground.

### BRIEF DESCRIPTION OF THE DRAWINGS

Details of one or more embodiments of the disclosure are set forth in the accompanying drawings and the description below. Other features and advantages of the disclosure will be apparent from the description, drawings and claims.

FIG. 1 is a block diagram illustrating an interaction among an electronic device, an MCU and a bus in accordance with an embodiment of the present disclosure;

FIG. 2 is a schematic diagram of a transceiving module in accordance with an embodiment of the present disclosure; and

FIG. 3 is a schematic diagram of a transceiving module in accordance with another embodiment of the present disclosure.

### DETAIL DESCRIPTION

Embodiments or examples of the disclosure illustrated in the drawings are now described in specific languages. It will nevertheless be understood that no limitation of the scope of the disclosure is thereby intended. Any alterations and modifications in the described embodiments, or any further applications of principles described in this document are contemplated as would normally occur to one of ordinary skill in the art to which the disclosure relates. Reference numerals may be repeated throughout the embodiments, but this does not necessarily require that feature(s) of one embodiment apply to another embodiment, even if they share the same reference numeral.

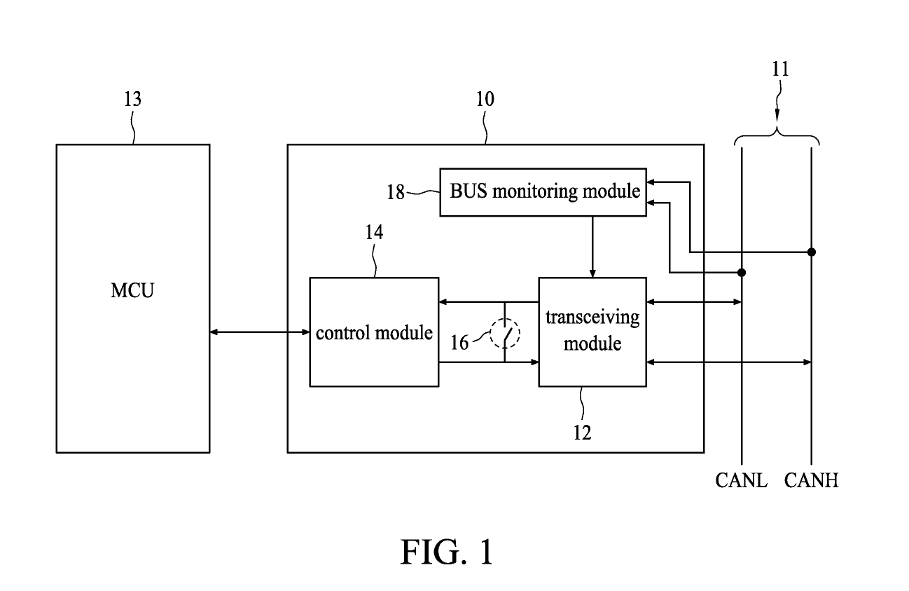

FIG. 1 is a block diagram illustrating an interaction among an electronic device 10, an MCU 13 and a bus 11 in accordance with an embodiment of the present disclosure. The electronic device 10 includes a high-speed control area network (CAN) transceiver, which may operate at a transmitting speed that is faster than 125 kilobits per second (Kb/sec). The electronic device 10 and the MCU 13 may together be termed as electronic control unit (ECU). The bus 11 includes a CAN high voltage channel CANH and a CAN low voltage channel CANL. The electronic device 10 is configured to electrically communicate with other ECUs over the bus 11.

In some embodiments, as shown in FIG. 1, the electronic device 10 includes a transceiving module 12, a control module 14, a switch 16, and a bus monitoring module 18. The control module 14 includes digital components. The transceiving module 12 includes analog components. The control module 14 and the transceiving module 12 are intergraded by, for example, a complementary metal-oxide-semiconductor (CMOS) process, into the electronic device 10. The CMOS process includes the use of, for example, a poly-silicon layer and four metal layers for 0.18 to 0.25 micrometer (μm) and 1.8 to 40 volts (V) applications.

In some embodiments, the electronic device 10 is equipped with a capability of fault tolerance for shorting a current of the CANH channel to a working voltage V_{DD} and shorting a current of the CANL channel to the ground.

The bus monitoring module 18 is configured to compare a positive voltage signal of the CANH channel with a reference voltage to determine whether the CANH channel violates a CAN protocol. Moreover, the bus monitoring module 18 is configured to compare a negative voltage signal of the CANL channel with the reference voltage to determine whether the CANL channel violates the CAN protocol. The bus monitoring module 18 transmits a signal with a logic level to the transceiving module 12 in order to disable the transceiving function of the transceiving module 12 when either one of the CANH channel and the CANL channel violates the CAN protocol.

The switch 16 is located between a first signal transmitting path from the control module 14 to the transceiving module 12, and a second signal transmitting path from the transceiving modules 12 to the control module 14. When the transceiving function of the electronic device 10 is found abnormal due to, for example, a missing acknowledgement of an electrical signal transmitted by the control module 14, the MCU 13 may output a signal with a logic level to conduct the switch 16. Therefore, a signal loop which serves as a signal testing loop for the MCU 13 is formed, including a signal outputting terminal of the control module 14, the conducted switch 16 and a signal receiving terminal of the control module 14.

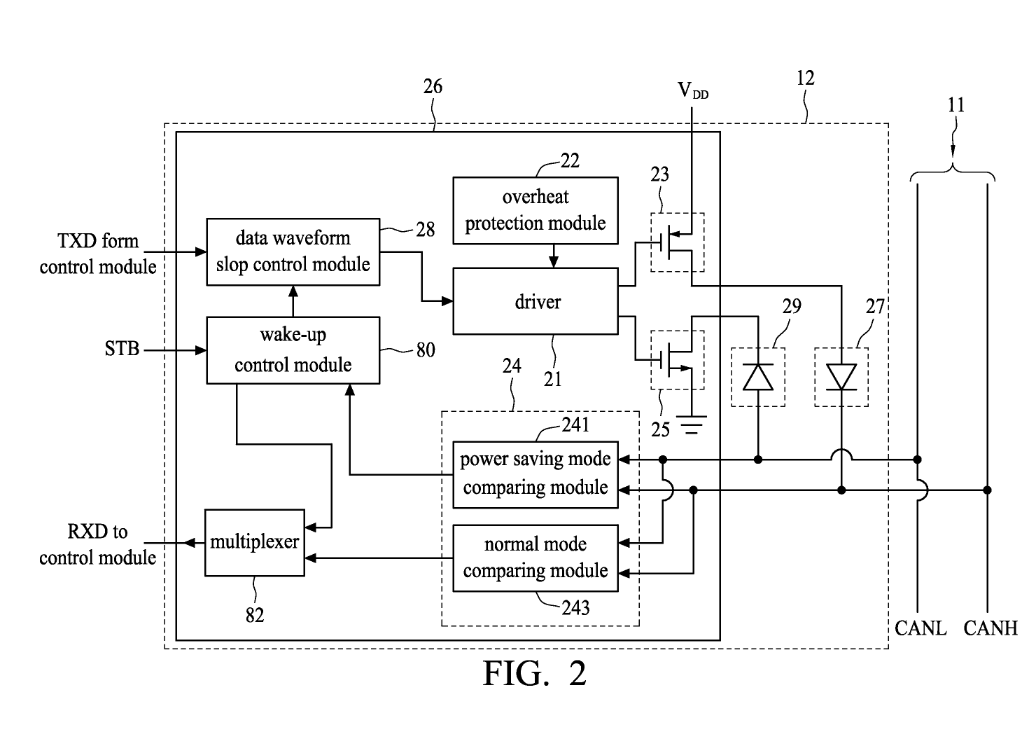

FIG. 2 is a schematic diagram of a transceiving module 12 in accordance with an embodiment of the present disclosure. As shown in FIG. 2, the transceiving module 12 includes a transceiving unit 26, a first isolator 27 and a second isolator 29. The transceiving unit 26 includes a driver 21, a first switch 23, a second switch 25, an overheat protection module 22, a voltage comparing module 24, a data waveform slop control module 28, a wake-up control module 80, and a multiplexer 82.

The overheat protection module 22, coupled to the driver 21, is configured to provide an overheat protection mechanism. The overheat protection mechanism is triggered to disable functions of the driver 21 when a surface temperature of the driver 21 reaches, for example, approximately 170 degrees Celsius.

The first switch 23 in some embodiments includes a transistor, such as a P-type metal-oxide-semiconductor field-effect transistor (MOSFET). A source of the P-type MOSFET is coupled to a working voltage V_{DD}. The second switch 25 in some embodiments includes another transistor, such as an N-type MOSFET. A source of the N-type MOSFET is coupled to ground. Gates of the MOSFETs are coupled to the driver 21. Moreover, the maximum withstanding voltage of the first switch 23 and the second switch 25 is approximately 40 V.

The first isolator 27 in some embodiments includes a first diode. The first isolator 27 is external to the transceiving unit 26. Moreover, the first isolator 27 is coupled between the first switch 23 of the transceiving unit 26 and the CANH channel. The first isolator is configured to isolate a spike current coming from the CANH channel.

The second isolator 29 in some embodiments includes a second diode. The second isolator 29 is external to the transceiving unit 26. Moreover, the second isolator 29 is coupled between the second switch 25 of the transceiving unit 26 and the CANL channel. The second isolator 29 is configured to direct a spike current from the CANL channel, via the second switch 25, to ground.

As shown in FIG. 2, the anode of the first diode is coupled to the drain of the P-type MOSFET, and the cathode of the first diode is coupled to the CANH channel of the bus 11. The anode of the second diode is coupled to the CANL channel of the bus 11 and the cathode of the second diode is coupled to the drain of the N-type MOSFET. The first diode and the second diode are configured to provide a protection mechanism for the transceiving module 12. The protection mechanism prevents the P-type MOSFET and the N-type MOSFET of the transceiving module 12 from being damaged by a spike current from the bus 11.

Operation of the protection mechanism is described as follows.

The bus 11 in a vehicle is liable to a positive spike current or a negative spike current, which may occur during igniting the engine of the vehicle, when the vehicle is hit by lightning, or in the discharge of static charge. In the case of a positive spike current event, the positive spike is isolated by the first diode 27 so that the first switch 23 is not damaged. In the case of a negative spike current event, the negative spike is directed to ground via the second diode 29 so that the second switch 25 is not damaged.

Moreover, as shown in FIG. 2, the voltage comparing module 24 includes a power saving mode comparing module 241 and a normal mode comparing module 243. Internal resistance of the power saving mode comparing module 241 and the normal mode comparing module 243 is adapted to prevent the voltage comparing module 24 from damage during a spike current event. In some embodiments, the power saving comparing module 241 includes an operational amplifier, and the normal mode comparing unit 243 includes another operational amplifier.

In normal operation, also referring to FIG. 1, the MCU 13 sends a working signal to the control module 14. The control module 14 generates a control data signal in response to the working signal, and sends the control data signal to the data waveform slop control module 28. In some embodiments, the data waveform slop control module 28 includes a resistor-capacitor (RC) circuit, and is configured to modify the waveform of the control data signal. The modified control data signal is then outputted to the driver 21.

Meanwhile, the wake-up control module 80 outputs a signal with a high logic level to the data waveform slop control module 28 in order to maintain the working ability of the data waveform slop control module 28. In some embodiments, the driver 21 outputs a signal with a low logic level to the P-type MOSFET and a signal with a high logic level to the N-type MOSFET in order to turn on the MOSFETs. As the P-type MOSFET is turned on, the CANH channel and an input terminal of the normal mode comparing unit 243 are pulled up to approximately the working voltage V_{DD} via the conducted P-type MOSFET and the first isolator 27.

In addition, the negative voltage signal on the CANL channel of the bus 11 is transmitted to another input terminal of the normal mode comparing unit 243.

The working voltage V_{DD} and the negative voltage signal are compared by the normal mode comparing unit 243. A signal with a logic level is then generated in response to the comparison result and is transmitted to the control module 14 via the multiplexer 82. The control module 14 generates a control signal in response to the signal with a logic level and transmits the control signal to the MCU 13.

Moreover, if a key of a car is removed for a certain amount of time after off ignition or if the MCU 13 enters into a power saving mode, the MCU 13 transmits a standby control signal to the control module 14. The control module 14 then enters into the power saving mode and transmits a standby signal STB to the wake-up mode control module 80. The wake-up mode control module 80 generates a signal with a low logic level in response to the standby signal STB to disable the data waveform slope control module 28. Since the data waveform slope control module 28 stops working, the driver 12 does not receive the control data signal from the data waveform slope control module 28. The driver 21 then enters into the power saving mode.

Furthermore, if the MCU 13, the control module 14 and the transceiving module 12 stay at the power saving mode and the voltage signals of the bus 11 are received by the transceiving module 12, the power saving mode comparing unit 241 compares a positive voltage signal from the CANH channel and a negative voltage signal from the CANL and generates a comparison result. The wake-up control module 80 generates a signal with a high logic level in response to the comparison result from the power saving mode comparing unit 241, and enables the data waveform slope control module 28.

The signal with a high logic level from the wake-up control module 80 is transmitted to the control module 14 to enable the control module 14. The control module 14 generates a wake-up control signal in response to the signal with a high logic level from the power saving mode comparing module 241, and enables the MCU 13.

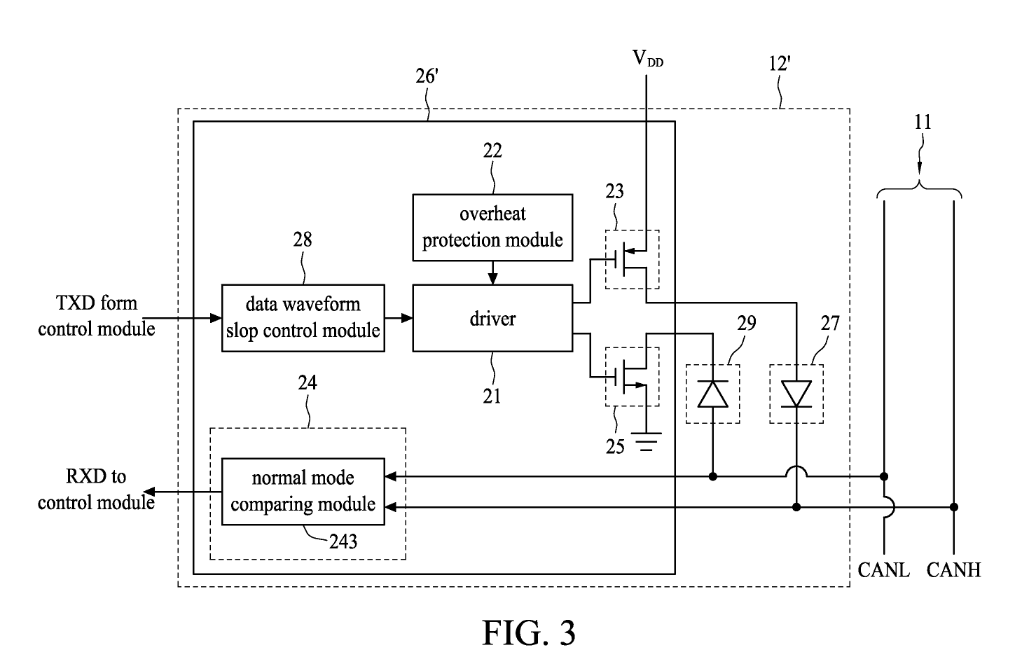

FIG. 3 is a schematic diagram of a transceiving module 12′ in accordance with another embodiment of the present disclosure. As shown in FIG. 3, the transceiving module 12′ includes a transceiving unit 26′ in addition to the first isolator 27 and the second isolator 29. The transceiving unit 26′ includes the driver 21, the first switch 23, the second switch 25, the overheat protection module 22, the voltage comparing module 24, and the data waveform slope control module 28. The overheat protection module 22 is coupled to the driver 21 and is configured to provide an overheat protection mechanism. The overheat protection mechanism is triggered to disable the driver 21 when a surface temperature of the driver 21 reaches approximately 170 degrees Celsius.

The first switch 23 includes a P-type MOSFET. The source of the P-type MOSFET is coupled to a working voltage V_{DD}. The second switch 25 includes an N-type MOSFET. The source of the N-type MOSFET is coupled to the ground. The gates of the MOSFETs are coupled to the driver 21.

The first isolator 27 includes a first diode. The first isolator 27 is external to the transceiving unit 26. Moreover, the first isolator 27 is coupled between the first switch 23 of the transceiving unit 26 and the CANH channel. The first isolator 27 is configured to isolate a spike current coming from the CANH channel.

The second isolator 29 includes a second diode. The second isolator 29 is external to the transceiving unit 26. Moreover, the second isolator 29 is coupled between the second switch 25 of the transceiving unit 26 and the CANL channel. The second isolator 29 is configured to direct a spike current coming from the CANL channel via the second switch 25 to ground.

As shown in FIG. 3, the anode of the first diode is coupled to the drain of the P-type MOSFET, and the cathode of the first diode is coupled to the CANH channel of the bus 11. Moreover, the anode of the second diode is coupled to the CANL channel of the bus 11 and the cathode of the second diode is coupled to the drain of the N-type MOSFET. The first diode and the second diode are configured to provide a protection mechanism to the transceiving module 12. The protection mechanism prevents the P-type MOSFET and the N-type MOSFET from being damaged by a spike current from the bus 11. Specifically, a positive spike current is isolated by the first diode 27, and a negative spike current is directed to ground via the second diode 29.

In normal operation, also referring to FIG. 1, the MCU 13 transmits a working signal to the control module 14. The control module 14 transmits a control data signal in response to the working signal to the data waveform slop control module 28. The data waveform slop control module 28 is configured to modify the waveform of the control data signal and output a modified control data signal to the driver 21.

Meanwhile, the wake-up control module 80 outputs a signal with a high logic level to the data waveform slop control module 28 in order to maintain the working ability of the data waveform slop control module 28. In some embodiments, the driver 21 outputs a signal with a low logic level to the P-type MOSFET and a signal with a high logic level to the N-type MOSFET in order to turn on the MOSFETs. As the P-type MOSFET is turned on, the CANH channel and an input terminal of the normal mode comparing unit 243 are pulled up to approximately the working voltage V_{DD} via the conducted P-type MOSFET and the first isolator 27.

In addition, the negative voltage signal on the CANL channel of the bus 11 is transmitted to another input terminal of the normal mode comparing unit 243. In some embodiments, the normal mode comparing unit 243 includes an operational amplifier.

The working voltage V_{DD} and the negative voltage signal are compared by the normal mode comparing unit 243. A signal with a logic level is then generated in response to the comparison result and transmitted to the control module 14. The control module 14 generates a control signal in response to the signal with a logic level and transmits the control signal to the MCU 13.

A number of embodiments of the disclosure have been described. It will nevertheless be understood that various modifications may be made without departing from the spirit and scope of the disclosure. Embodiments of the disclosure are applicable in various design choices.

The above description includes exemplary operations, but these operations are not necessarily required to be performed in the order shown. Operations may be added, replaced, changed order, and/or eliminated as appropriate, in accordance with the spirit and scope of the disclosure. Accordingly, the scope of the disclosure should be determined with reference to the following claims, along with the full scope of equivalences to which such claims are entitled.

What is claimed is:

1. An electronic device, comprising:
a control module configured to generate a control signal in response to a signal from a micro-control unit;
a transceiving module configured to, in response to the control signal, broadcast a first electrical signal to a bus and receive a second electrical signal from the bus, the transceiving module comprising:
a transceiving unit, further comprising:
a first switch; and
a second switch;
a first isolator, external to the transceiving unit and coupled between the first switch and the bus, the first isolator configured to isolate a first spike current coming from the bus; and
a second isolator, external to the transceiving unit and coupled between a terminal of the second switch and the bus, the second isolator configured to direct a second spike current coming from the bus to the ground.

2. The electronic device of claim 1, wherein the first switch includes a first transistor, and the second switch includes a second transistor.

3. The electronic device of claim 2, wherein the first transistor includes a P-type metal-oxide-semiconductor field effect transistor (MOSFET).

4. The electronic device of claim 2, wherein the second transistor includes an N-type MOSFET.

5. The electronic device of claim 1, wherein the first isolator includes a diode, which includes an anode coupled to the first switch and a cathode coupled to the bus.

6. The electronic device of claim 1, wherein the second isolator includes a diode, which includes an anode coupled to the bus and a cathode coupled to the second switch.

7. The electronic device of claim 1 further comprising a switch between a first signal transmitting path from the control module to the transceiving module, and a second signal transmitting path from the transceiving modules to the control module.

8. The electronic device of claim 1, wherein the transceiving module includes an overheat protection module coupled to a driver.

9. The electronic device of claim 8, wherein the overheat protection module is configured to disable the driver when the driver reaches a temperature threshold.

10. A signal transceiving module, comprising:
a transceiving unit, further comprising:
a first switch; and
a second switch;
a first isolator, external to the transceiving unit and coupled between the first switch and a bus, the first isolator configured to isolate a first spike current coming from the bus; and
a second isolator; external to the transceiving unit and coupled between a terminal of the second switch and the bus, the second isolator configured to isolate a second spike current coming from the bus.

11. The transceiving module of claim 10, wherein the first switch includes a first transistor and the second switch includes a second transistor.

12. The electronic device of claim 11, wherein the first transistor includes a P-type MOSFET.

13. The electronic device of claim 11, wherein the second transistor includes an N-type MOSFET.

14. The transceiving module of claim 10, wherein the first isolator comprises a diode, which includes an anode coupled to the first switch and a cathode coupled to the bus.

15. The transceiving module of claim 10, wherein the second isolator comprises a diode, which includes an anode coupled to the bus and a cathode coupled to the second switch.

16. The transceiving module of claim 10, wherein the transceiving module includes an overheat protection module coupled to a driver.

17. The electronic device of claim 16, wherein the overheat protection module is configured to disable the driver when the driver reaches a temperature threshold.
